(19) United States
(12) Patent Application Publication
(10) Pub. No.: US 2025/0281961 A1
(43) Pub. Date: Sep. 11, 2025

(54) METHOD FOR PRODUCING AT LEAST ONE COMPONENT ELEMENT FOR A FURNITURE FITTING

(71) Applicant: Julius Blum GmbH, Hoechst (AT)

(72) Inventor: Olaf ISELE, Lustenau (AT)

(21) Appl. No.: 19/219,466

(22) Filed: May 27, 2025

Related U.S. Application Data
(63) Continuation of application No. PCT/AT2023/060381, filed on Nov. 10, 2023.

(30) Foreign Application Priority Data
Dec. 2, 2022 (AT) A 50916/2022

(51) Int. Cl. B21D 11/10; A47B 88/40; B21D 17/04

(52) U.S. Cl. CPC B21D 11/10; A47B 88/40; B21D 17/04; A47B 2210/0002

(57) ABSTRACT

A method for producing a component element for a furniture fitting, in particular a rail of a drawer pull-out guide, includes in chronological order: providing a flat metal sheet with a longitudinal extent, with two outer faces, and with two side faces spaced apart by a width of the metal sheet, as a semi-finished item of the at least one component element, preferably a rail. The metal sheet is provided, preferably by a stamping punch and/or a stamping roll, with a notch on an outer face. The notch is arranged substantially parallel to the longitudinal extent, the metal sheet is mechanically separated in the region of the at least one notch, preferably being broken off, particularly preferably kinked and divided, and the separated metal sheet is bent such that, in a cross section orthogonal to the longitudinal extent, a profile of the component element, preferably a rail, is obtained.

The present application is a continuation of International Application PCT/AT2023/060381 filed on Nov. 10, 2023. Thus, all of the subject matter of International Application PCT/AT2023/060381 is incorporated herein by reference.

### BACKGROUND OF THE INVENTION

The invention relates to a method for manufacturing at least one component element for a furniture fitting, in particular a rail, and especially for a drawer pull-out guide. Furthermore, the invention relates to a drawer pull-out guide for movably mounting a drawer on a furniture carcass.

A general problem in the manufacture of component elements such as rails, especially for the furniture industry or furniture sector, is the need for metal, which is necessary for the production of rails or similar items. High material usage leads to high weight and increased costs in series production. It is therefore desirable to use as little metal as possible, especially since the resource-saving use of raw materials has both ecological and economic advantages.

One measure for saving metal is the use of thin-walled metal sheets, which also has the advantage of reducing the weight of the rail. In the prior art, rails, especially for the furniture industry, are usually cut to length by means of a separating cut, for example by a saw blade of defined width, so that a rail with defined dimensions is produced. However, this produces a large amount of metal as waste product, and there is a long-standing need in the furniture industry to achieve material savings by eliminating such metal scrap.

A method for manufacturing tubes and extruded profiles is already known from document DE 10 2007 018 927 A1, wherein chamfers in the tubes or extruded profiles are used to minimize the risk of injury and the degree of deformation after a cutting step without generating scrap.

A disadvantage of the prior art is that only semi-finished products as such are used for further transport of the semi-finished products, but the tubes and extruded profiles must then be adapted to the respective area of application and the design of the semi-finished products is determined by the initial forming process. However, there is no process for a specific area of application with defined tasks, individual purposes, structural designs, and specific challenges.

In order to further reduce material waste, attempts are made to position cutting edges for a punching process very close to each other or to arrange them so that they overlap relative to each other, so that, for example, the optimum geometry of the strip-shaped semi-finished product can be used for a rail. However, this also results in sharp-edged longitudinal surfaces in the subsequently bent profile of the rail, which increases the risk of injury during use and requires time-consuming post-processing steps or separate protective devices to reduce the risk of injury.

### SUMMARY OF THE INVENTION

The objective technical task of the present invention is therefore to provide an improved method for manufacturing at least one component element for a furniture fitting and an improved drawer pull-out guide, in which the disadvantages of the prior art are at least partially eliminated, and which are characterized in particular by a reduction in metal waste during the manufacture of component elements for a furniture fitting and a reduced risk of injury during use of the manufactured component elements.

Accordingly, the invention includes the following process steps carried out in chronological order:
a flat metal sheet with a longitudinal extent, two outer surfaces, and two side faces spaced apart by a width of the metal sheet is provided as a semi-finished product of at least one component element, preferably a rail,
the metal sheet is provided with at least one notch on at least one outer surface, preferably by means of at least one stamping punch and/or at least one stamping roll, wherein the at least one notch is arranged substantially parallel to the longitudinal extent,
the metal sheet is mechanically separated in the region of the at least one notch, preferably broken off, particularly preferably bent and divided,
the separated metal sheet is bent so that, in a cross-section orthogonal to the longitudinal extent, a profile of the at least one component element, preferably a rail, is formed.

This makes it possible to effectively prevent material waste, which in conventional component elements such as rails or similar in the furniture industry is produced by the chip-removing process of separating the rail from a profile material. In mass production, this results in reduced disposal and/or recycling costs for metal scrap, cleaner component parts and a cleaner working environment, less reworking, and significant cost savings in production, as processing steps and punching or cutting waste, caused, for example, by the cutting width of a cutting tool, are accumulated with each component element manufactured.

In addition, a longitudinal surface of the profile can be generated automatically at the same time, which has a taper and is designed to be burr-free (due to plastic deformation) in such a way that the risk of injury when using the component element in furniture can be significantly reduced. In general, only one of the longitudinal surfaces can be machined in this way before bending, for example to make efficient use of the width of the raw material, or both longitudinal surfaces can be provided with a notch with a taper remaining on the component element during breaking off, separating, pulling off, etc. In general, the taper can also be removed in a subsequent process step.

The metal sheet is preferably a steel sheet. However, in the context of the invention, the term “metal sheet” is to be interpreted broadly enough to include other non-metallic plate-shaped materials, such as plastic sheets, composite material sheets, composite material plates, or the like, which can be regarded as metal sheet in non-metallic form. A metal sheet of a metallic design is particularly preferred.

Mechanical separation such as breaking, without the use of cutting tools such as saw blades or punching tools, is generally an unusual measure in automated production in the furniture industry, especially for component elements such as rails. This is particularly true because, until now, meticulous efforts have been made to minimize the impact on the complex geometric designs of rails or similar component elements—primarily due to the large material thicknesses and high cross-sectional diameters of the profiles, combined with high requirements for geometric accuracy and precision of the profile—by using chip-removing separation methods. According to the invention, this can also be ensured, whereby the geometry of the profile of at least one component element remains precisely maintained in cross-section and over the entire length.

Particularly lightweight component elements with thin walls can be manufactured very cost-effectively using this process, with minimal force and low plastic deformation, while also ensuring that the component elements have a highly attractive appearance.

If the metal sheet (for example, flat steel) is profiled by notches prior to a bending process, complex geometries can also be formed during the bending process to produce the at least one component element. The at least one notch follows the complex geometry of the profile of the at least one component element in order to be able to produce component elements particularly efficiently in series. The profile of the at least one component element is not undesirably impaired by the at least one notch, in particular due to its introduction before the bending process.

The technical term “mechanical separation” refers to all separation processes that do not generate any material waste, for example through chip-removing separation processes.

The component element may, for example, be a rail such as a carcass rail or a drawer rail, in particular for a drawer pull-out guide as a furniture fitting, or a hinge arm, an adjusting arm, a hinge part, a housing part or the like for a flap fitting or other furniture fitting, such as a hinge.

In addition, there is the positive feature that the at least one component element, due to the absence of burrs-resulting from a chip-removing separation process-poses a lower risk of injury to a user of a piece of furniture and/or an installer during installation of the component element, and no reworking is necessary. Furthermore, cutting tools, for example, have a limited service life due to wear and tear, whereby maintenance and/or repair work in the mass production of component elements can be significantly reduced. The transverse extent in width (and generally also the longitudinal extent) of the at least one component can be flexibly adjusted by positioning the at least one notch, whereby the metal sheet does not have to be provided in advance with the appropriate width dimensions (or length dimensions).

The at least one component element may, for example, be a furniture rail, a carcass rail, a center rail (preferably located at least in part between the carcass rail and the drawer rail), a drawer rail, a container rail (preferably for arranging a drawer on the container rail), etc. Through cold work in a separation-free, chip-free, and preferably burr-free mechanical breaking process, the at least one notch can act as a predetermined breaking point, whereby particularly favorable material characteristics of the component element are achieved in an area around the at least one notch.

The component element can be broken off using non-cutting separating tools such as a ram or similar, or manually. A semi-automatic or automatic hydraulic or pneumatic drive is particularly preferred in order to remove the at least one component element from a remaining material by pressure and/or traction (for example by pulling apart), wherein no punching tool, saw, or grinding wheel (with conditional burr and post-processing steps) is required. The at least one notch can act as a defined break-off edge for forming the at least one component element under bending stress, whereby the tensile/compressive stresses are focused on the at least one notch.

The at least one notch can be made in the strip-shaped metal sheet using, for example, an embossing die such as a notching die or an stamping roll such as a notching roll, wherein, in general, after mechanical separation (breaking off), a taper in the form of at least one chamfer is arranged on an end face of the profile of the component element. Preferably, the at least one notch comprises two flanks, wherein after the breaking-off process, one flank is assigned to the at least one component element.

As stated at the outset, protection is also sought for a drawer pull-out guide for the movable mounting of a drawer on a furniture carcass, comprising:
at least one carcass rail to be fastened to the furniture carcass, and
at least one drawer rail to be connected to the drawer, which is mounted so as to be displaceable in a longitudinal direction relative to the at least one carcass rail, and
optionally at least one center rail, which is arranged at least in some areas between the at least one carcass rail and the at least one drawer rail, and
optionally at least one container rail for arrangement on the at least one drawer rail and/or on the drawer.

The at least one carcass rail and/or the at least one drawer rail has a profile formed from at least one flat metal sheet in a cross-section orthogonal to the longitudinal direction, and the at least one carcass rail and/or the at least one drawer rail and/or the at and/or the at least one least one center rail, if present, container rail, if present, are manufactured as component elements by such a process that at least one, in particular two, longitudinal surface of the profile of the at least one carcass rail and/or the at least one drawer rail and/or the at least one center rail, if present, and/or the at least one container rail, if present, is formed with a taper.

However, the method can also be used for other furniture fittings apart from drawer pull-out guide.

The process can be used to generate a taper on at least one longitudinal surface of the profile. A center rail is not absolutely necessary, but can ensure that the drawer can be pulled out completely relative to the furniture carcass and act as an intermediate link between a carcass rail and a drawer rail. A container rail is not absolutely necessary, but can, for example, act as a connecting element between a side wall of the drawer or a container and a drawer rail in the case of a preferably metal drawer frame. The container rail is preferably connected to the drawer pull-out guide by a material bond or by means of a collar on a frame cap and by vertical support on the drawer rail.

The longitudinal direction is generally identical to the longitudinal extent of the metal sheet. It is particularly preferred that the taper extends over the entire profile of the at least one component element in the longitudinal surface (and, if applicable, in the end surface or end surfaces).

According to an advantageous embodiment of the invention, at least two opposing notches, preferably arranged orthogonally in one direction on at least one of the two outer surfaces, are arranged on the two outer surfaces of the metal sheet.

Superimposed notches can be used to generate a particularly symmetrical longitudinal surface (or end surface) of the component element, whereby notches arranged opposite and/or next to each other can generally have different depths and/or notch geometries.

Advantageously, the bent metal sheet is mechanically separated, preferably broken off, and particularly preferably bent and divided at at least two, preferably at least two superimposed notches.

In general, however, it is also conceivable to use only one notch for the mechanical separation process.

It has proven advantageous that the at least one component element is formed with a substantially burr-free taper on at least one, preferably two, longitudinal surfaces of the profile, wherein it is preferably provided that the taper has a taper cross-section orthogonal to the longitudinal extent of the metal sheet substantially in the form of a triangle, preferably an isosceles triangle, wherein the tapered cross section is particularly preferably convex and/or concave.

The reduction is generally achieved by a combination of cold work through the introduction of at least one notch and plastic deformation in the mechanical separation step and generally extends over the entire longitudinal surface in the unfolded state of the profile, which represents one side surface of the underlying metal sheet.

According to an advantageous embodiment of the invention, the metal sheet is broken in the region of the at least one notch without separation, punching or cutting. The at least one notch is used as a predetermined breaking point during bending or separating of the metal sheet, and it is preferably provided that the at least one component element is formed without post-processing.

The method of mechanical separation is generally arbitrary, whereby no chips are produced during mechanical separation and, if necessary, chip-removing finishing may be provided-however, this is not absolutely necessary in order to be able to use the at least one component element directly as a furniture rail without a high risk of injury, for example.

It has proven advantageous for the metal sheet to have a wall thickness in the range of 0.5 mm and 1.8 mm, preferably between 0.6 mm and 0.8 mm.

The wall thickness of less than 1.8 mm-which is used in conventional components such as rails-results in a particularly lightweight component element that can be mechanically separated very easily using the method according to the invention and has low material consumption.

An advantageous variant of the present invention consists in folding the metal sheet in the region of at least one longitudinal surface to form a fold, preferably during bending of the metal sheet.

A fold can be used to double the wall thickness locally in order to increase the strength and/or stability properties in desired areas of the component element without doubling the weight of the component element itself.

It is particularly preferred that the at least one notch in the form of a groove or a profile with an opening angle in the range between 40° and 140°, preferably between 75° and 105°, particularly preferably essentially 90°, is made in the metal sheet.

For example, identical or different depths and/or geometries can be used for the at least one notch in order to act as a defined predetermined breaking point for tearing off and/or breaking off.

In one embodiment of the invention, the at least one notch is provided with a notch cross-section orthogonal to the longitudinal extent of the metal sheet in the form of a triangle, a trapezoid, an ellipse segment, and/or a circle segment.

It is particularly preferred that the at least one notch after the bending process is located on the profile of the metal sheet in such a way that between 0.05 mm and 0.2 mm, preferably between 0.08 mm and 0.12 mm, remain between the two outer surfaces. It is particularly preferred that the at least one notch has a trapezoidal shape, wherein the smallest side length of the trapezoid between the two outer surfaces is between 0.1 mm and 0.4 mm, preferably between 0.15 mm and 0.25 mm.

According to a preferred embodiment of the invention, for each component element, exactly two or four notches are made in the flat metal sheet parallel to the longitudinal extent, arranged in pairs on the two outer surfaces. The component element is formed by breaking off once or twice, preferably consecutively, over the two or four notches in the metal sheet.

This facilitates the mechanical separation process and maximizes material savings.

It has proven advantageous to provide the metal sheet with a large number of notches arranged in pairs on both outer surfaces and then to mechanically break off a large number of component elements.

This allows a large quantity of component elements to be produced efficiently in series and, preferably, without interruption using the same semi-finished product.

It is particularly preferred that at least one further notch is provided in the metal sheet transversely, preferably substantially parallel to the longitudinal extent. Preferably, the metal sheet, which is particularly preferably bent, is mechanically separated in the region of the at least one further notch to form at least one further taper which is substantially burr-free on at least one end face of the component element, particularly preferably broken off or bent and divided.

If, for example, both longitudinal surfaces and both end surfaces of a rail are generated by one notch or further notches (so that there are generally four connected and/or adjacent tapers along the contour of the rail), a reduction in material waste and a particularly high degree of safety can be ensured.

Preferably, at least one, in particular two, end surfaces of the profile of the at least one carcass rail and/or the at least one drawer rail and/or the at least one center rail, if present, and/or the at least one container rail, if present, are designed with a further taper.

Furthermore, it is preferable that the taper and/or further taper comprises an angle in the range between 60° and 140°, preferably between 75° and 105°, particularly preferably essentially 90. Preferably, at least one, preferably both, longitudinal surface and/or end surface are essentially burr-free.

The geometry of the taper can be flexibly adjusted via the geometry of the at least one notch.

In a further embodiment, the at least one carcass rail and/or the at least one drawer rail can have at least one fastening section with a fastening side which, when mounted on the furniture carcass or at least one furniture part, can be brought into contact with the furniture carcass or the at least one furniture part at least in sections. The at least one fastening section has at least one, preferably circular, opening for the passage of a fastening means, preferably a screw, and the at least one opening is spaced apart from one of the fastening sides by a material thickness of the fastening section, preferably between 0.5 mm and 1.8 mm, particularly preferably between 0.6 mm and 0.8 mm, spaced apart from the fastening side by a bead which projects transversely from the second side.

The bead reinforces the circumferential edge of the opening, allowing the force exerted from the underside of a screw head to be distributed over a larger area. The bead reduces the screw head sinking into the thin-walled metal of the fastening section. This reduces the risk of damage to the circumferential edge of the opening and saves material.

According to an advantageous embodiment of the invention, the at least one carcass rail and/or the at least one drawer rail and/or the at least one center rail, if present, and/or the at least one container rail, if present, is folded into a fold in the region of at least one profile surface of the profile.

The fold allows the load-bearing capacity of the rail or other component element relative to the weight of the rail/component element to be increased.

It is particularly preferred that the at least one tapering and/or the at least one further tapering has a tapering cross-section parallel and/or orthogonal to the longitudinal extension of the metal sheet, essentially in the form of a triangle, preferably an isosceles triangle. Preferably, the tapering cross-section is convex and/or concave.

According to a preferred embodiment, the profile is provided with at least one embossing, preferably oriented orthogonally to the longitudinal extent of the metal sheet, for stiffening the profile. Preferably, the at least one embossing extends over at least two substantially orthogonal profile surfaces and/or at least two embossings are provided, which are arranged alternately in the direction of an inner region and in the direction of an outer region of the profile.

The at least one embossing promotes the stability and/or strength of the at least one component element with particularly efficient material requirements.

### BRIEF DESCRIPTION OF THE DRAWINGS

Further details and advantages of the present invention will be explained in more detail below with reference to the drawings, in which:

FIG. 1a, 1b show a drawer pull-out guide according to a particularly preferred embodiment comprising a carcass rail and a drawer rail, as well as the drawer rail isolated in perspective view.

FIG. 2a-2f show process steps in a preferred method for manufacturing a rail for drawer pull-out guides according to the embodiment shown in FIG. 1a,

FIG. 3 show chronological steps in a preferred method for manufacturing a rail according to the embodiment shown in FIG. 1b,

FIG. 4a-4c are schematic illustrations of mechanical separation at notches in a metal sheet,

FIG. 5a-5f show a preferred method comprising the introduction of notches, mechanical separation, and the generation of tapers on longitudinal surfaces of a component element to be formed for a furniture fitting,

FIG. 6 is a schematic representation of a preferred method for manufacturing a rail, wherein additional notches are used transversely to a longitudinal extent.

### DETAILED DESCRIPTION OF THE INVENTION

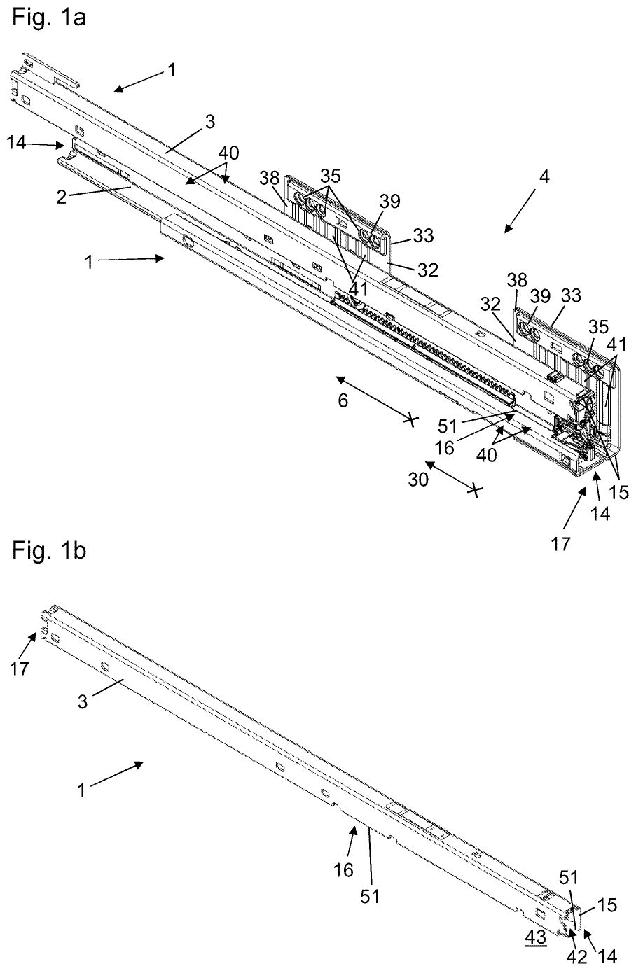

FIG. 1a shows a drawer pull-out guide 4 for movably mounting a drawer on a furniture carcass, comprising a carcass rail 2 to be fastened to the furniture carcass and a drawer rail 3 to be connected to the drawer, which is mounted so as to be displaceable relative to the carcass rail 2 in a longitudinal direction 30. The carcass rail 2 and the drawer rail 3 have a profile 15 formed from flat metal sheet 5 in a cross-section 14 orthogonal to the longitudinal direction 30.

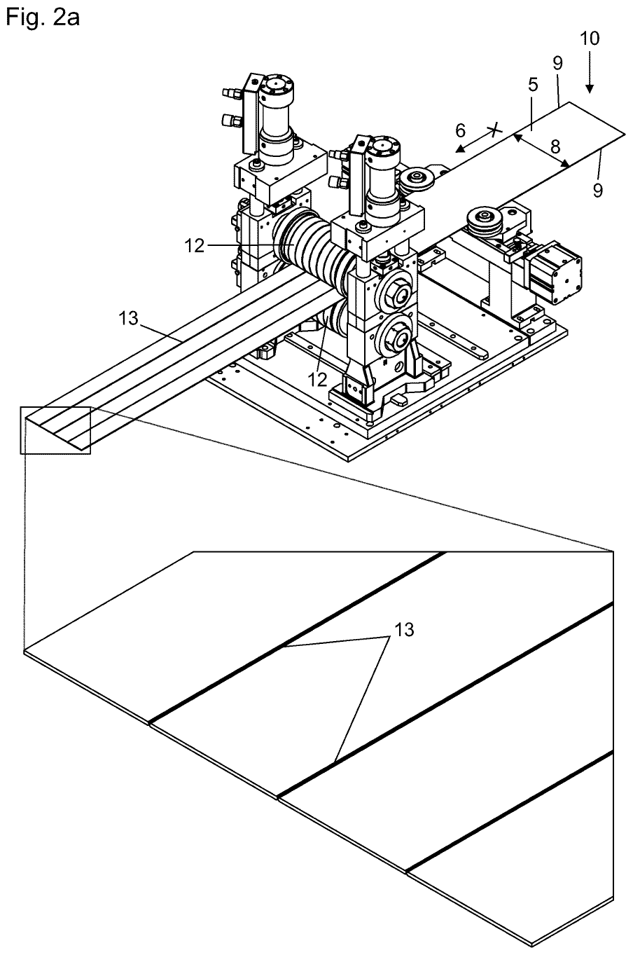

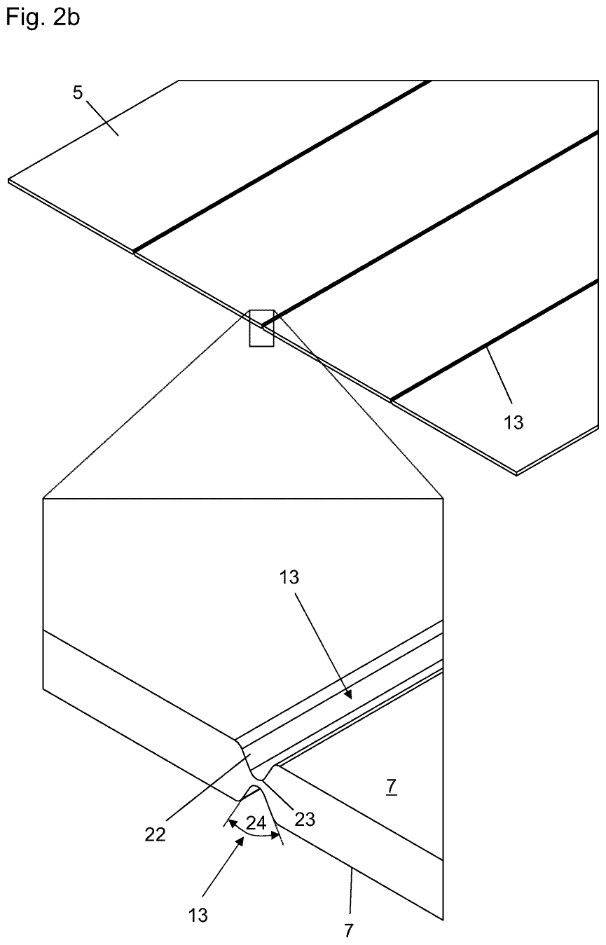

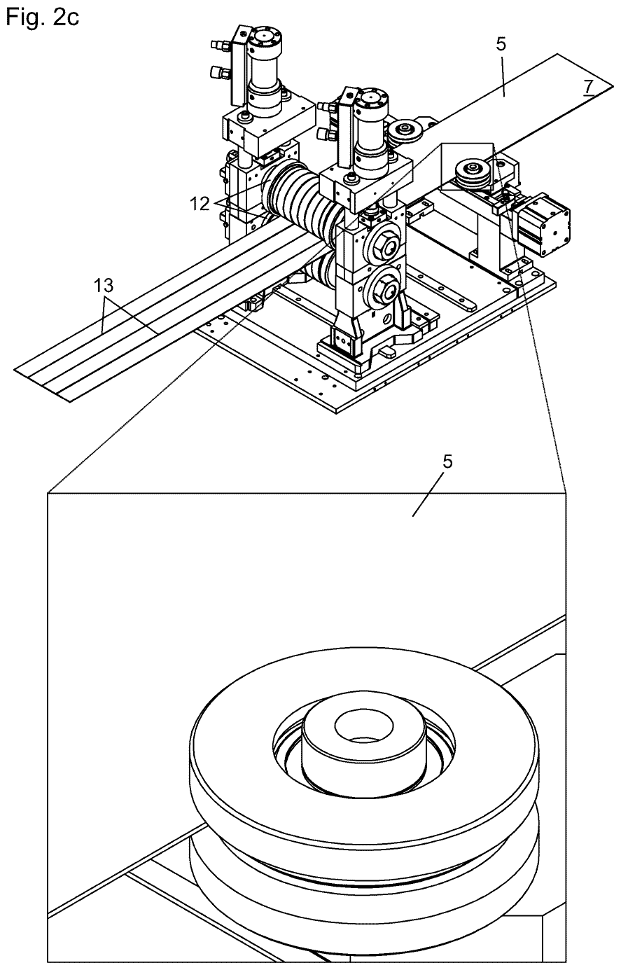

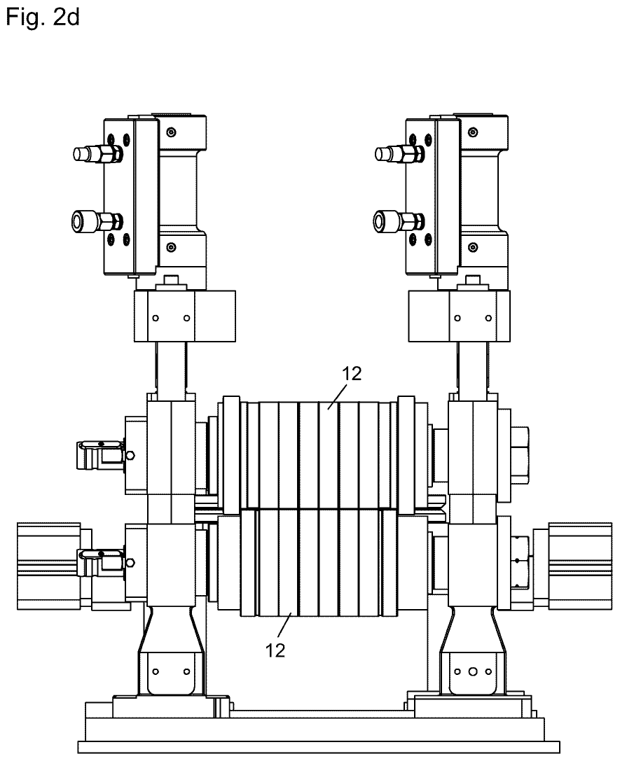

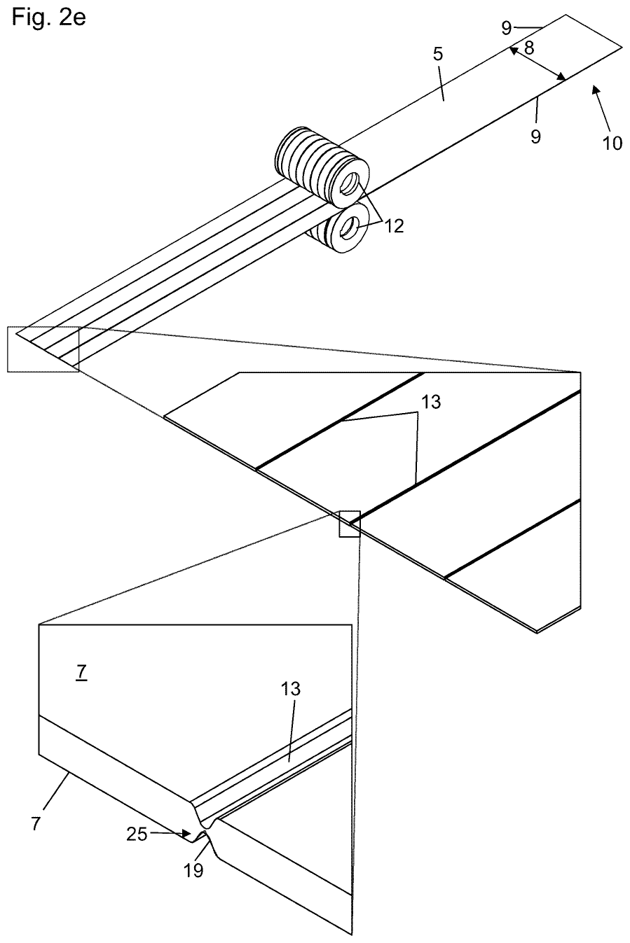

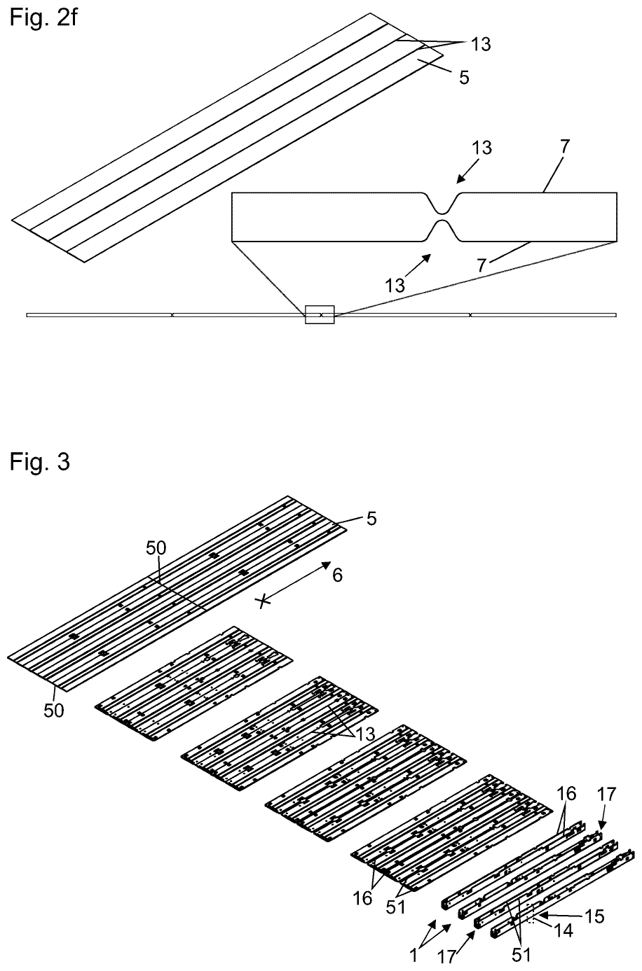

The carcass rail 2 and the drawer rail 3 are manufactured as component elements 1 in such a way that at least one (generally both) longitudinal surface 51 of the profile 15 of the carcass rail 2 or the drawer rail 3 is formed with a taper 16, wherein the process steps for forming the tapers 16 are explained in detail in FIGS. 2a to 5f.

The carcass rail 2 has a fastening section 32 with a fastening side 33 which, when mounted on a furniture carcass, can be brought into contact with the furniture carcass, wherein the fastening section 32 has circular openings 35 for the passage of fastening means, such as screws. The openings 35 are surrounded on a second side 38, which is spaced apart from the fastening section 32 by a material thickness of between 0.5 mm and 1.8 mm, by a bead 39 which projects transversely from the second side 38.

The profile 15 of the carcass rail 2 comprises embossings 41 oriented orthogonally to the longitudinal extent 6 of the metal sheet 5 for stiffening the profile 15, wherein the drawer rail 3 may also generally have embossings 41 extending, for example, over two orthogonally adjacent profile surfaces to increase stability. The embossings 41 of the carcass rail are arranged alternately in the direction of an inner area 42 and in the direction of an outer area 43 of the profile 15.

FIG. 1b differs from FIG. 1a only in that the drawer rail 3 is shown in a disassembled state. The drawer rail has two longitudinal surfaces 51 and two end surfaces 17 of the profile 15. Further tapers 52 may generally be arranged on the end surfaces 17. According to the invention, a taper 16 is arranged on at least one of the two longitudinal surfaces 51, which is caused by a notch 13 that was arranged parallel to the longitudinal extent 6 during the production process.

FIG. 2a shows the insertion of the notches 13, which are arranged on the outside of the metal sheet 5. The enlarged detail shows that three notches 13 have been made parallel to the longitudinal direction 30 using stamping rolls 12 (or, in general, stamping punches in the sense of a kerf). Material for five rails can be cut from the width 8 of the metal sheet 5.

FIG. 2b shows an enlarged view of the geometry of the notch shape, wherein the notch 13 is in the form of a groove 22 comprising a rounded profile 23 with an opening angle 24 in the range between 75° and 105° in the metal sheet 5.

The notches 13 have a notch cross-section 25 orthogonal to the longitudinal extent 6 of the metal sheet 5 in the form of a triangle 19, wherein the shape is generally arbitrary and can also be designed, for example, as a trapezoid, ellipse segment, or circle segment.

FIG. 2c shows a rolling device for processing semi-finished products or raw materials for the manufacture of rails, wherein two stamping rolls 12 arranged parallel to each other and orthogonal to the longitudinal direction 30 and longitudinal extent 6 are provided for introducing the notch 13.

The enlarged detail shows one of two further rolls, which are arranged orthogonally to the embossing rolls 12 and are intended for rounding the outer edges. This rounding step can be omitted for longitudinal surfaces 51, which have been formed by notches 13 and thus have tapered edges 16.

FIG. 2d shows the rolling device according to FIG. 2c in a front view, wherein the metal sheet 5 is continuously fed through between the stamping rolls 12.

FIG. 2e, in which the stamping rolls 12 are shown in simplified form on the metal sheet 5, illustrates an example of a method for manufacturing a component element 1 for a furniture fitting in the form of a rail for mounting on a drawer pull-out guide 4: A flat metal sheet 5 (usually sheet steel, although aluminum sheets or plastic-like plates are also possible) with a longitudinal extent 6, two outer surfaces 7, and two side faces 9 spaced apart by a width 8 of the metal sheet 5 is provided as a semi-finished product 10 or raw material for the rail.

Subsequently, the metal sheet 5 is provided with notches 13 by the two stamping rolls 12 on both outer surfaces 7, wherein the notches 13 are arranged parallel to the longitudinal extent 6 (or the longitudinal direction 30). Chronologically following this, the metal sheet 5 is mechanically separated (without chips) in the area of the notch 13, whereby the metal sheet parts are broken off, for example by bending and splitting, or torn off relative to each other by pulling.

The separated metal sheet 5 is then bent so that a profile 15 of the component element 1 (in this embodiment a rail) is formed in a cross-section 14 orthogonal to the longitudinal extent 6. Before or after the bending process, the metal sheet 5/profile 15 can be provided with punched or profiled features.

FIG. 2f shows the notched metal sheet material before mechanical separation in perspective view, a view from the front, and an enlarged detail section in the area of the cross section of notch 13.

FIG. 3 illustrates different stages in a preferred manufacturing process for the component elements in press production, whereby the metal sheet 5 is profiled and punched and divided into segments by plastic (chip-free) deformation in order to bend a large number rails. Segmentation takes place orthogonally of to the longitudinal extent 6 and in the direction of the longitudinal extent 6, whereby chip-removing processes may generally also be provided for separating the segments in the longitudinal direction 30 of the metal sheet 5.

The metal sheet 5 was provided with a large number of notches 13 (and further notches 50) arranged in pairs on the two outer surfaces 7 so that a large number of component elements 1, which generally still had to be bent, could then be broken off mechanically.

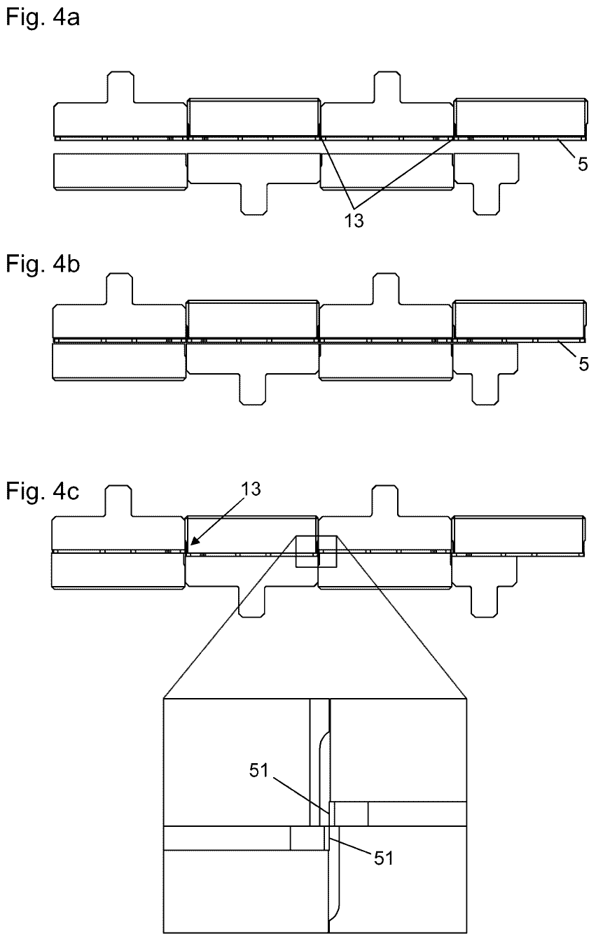

FIGS. 4a to 4c illustrate the mechanical separation process (perpendicular to the longitudinal extent 6) using the example of individual rails via breaking tools in the form of clamps.

In FIG. 4a, the clamps are moved toward each other so that the metal sheet 5 with the notches 13 is clamped between the clamps, as shown in FIG. 4b.

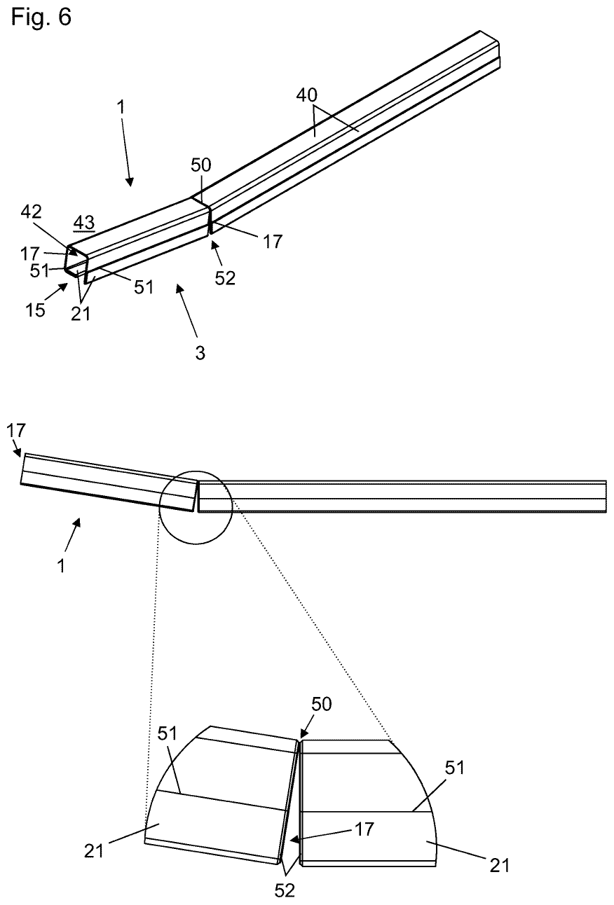

In FIG. 4c, pairs of clamps are shifted relative to adjacent pairs of clamps so that the metal sheet is mechanically divided at the notches 13 as the predetermined breaking point. The rails are thereby separated from the semi-finished product by breaking, whereby bending or buckling processes may also be provided for mechanical separation (see FIG. 6).

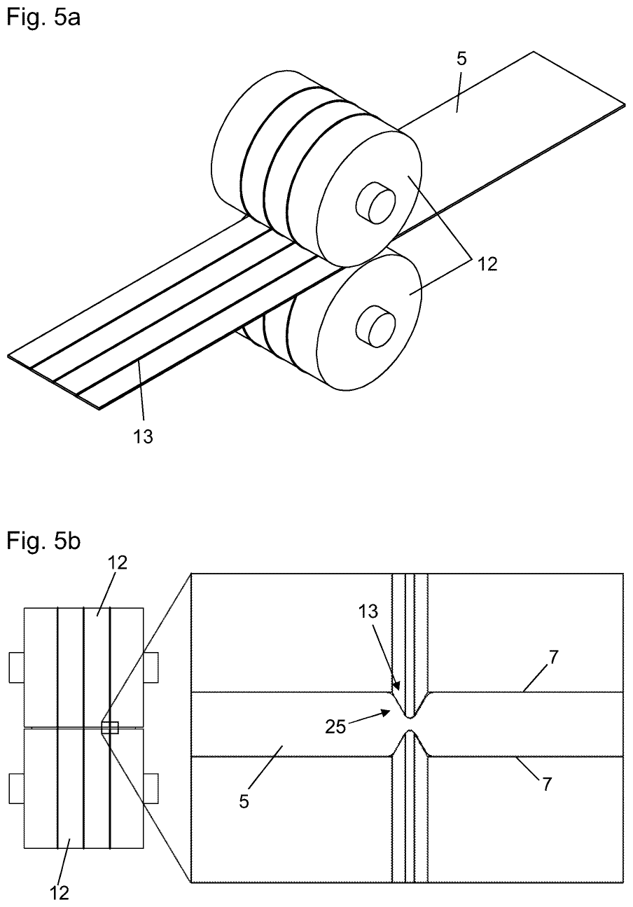

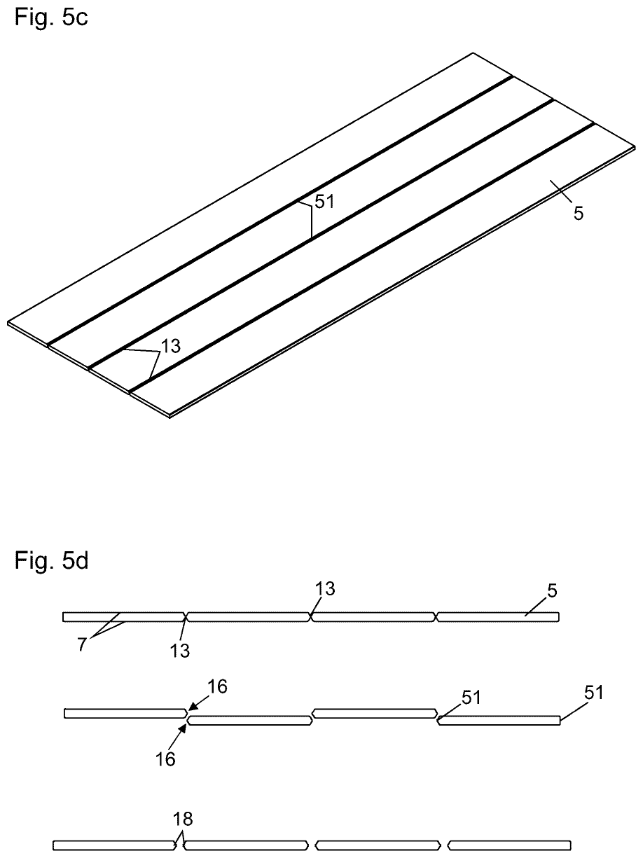

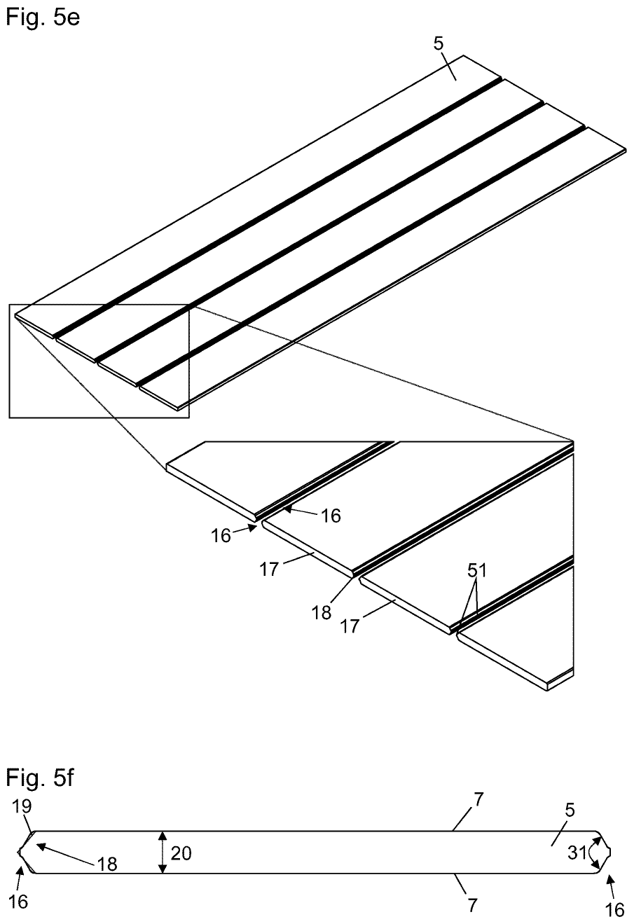

In the perspective view in FIG. 5a and the side view in FIG. 5b with the corresponding detailed section, the notches 13 can be seen, which are made in the raw material by plastic deformation in order to generate a division transverse to the profiling direction.

When the notched metal sheet material is plastically deformed as shown in FIG. 5c, the metal sheet 5 is segmented along the contours defined by the notches 13, as shown schematically in FIG. 5d: After mechanical separation, four metal sheet parts are present, which can be used to manufacture component elements 1, whereby the outer segments will have a burr-free taper 16 on a longitudinal surface 51 on the profile 15 to be bent, and the two inner segments can be used for profiles 15 with tapers 16 formed on two longitudinal surfaces 51.

In FIG. 5e, the mechanical division of the metal sheet 5 via the notches 13 transverse to the longitudinal extent 6 has already been carried out. FIG. 5f shows a view in the longitudinal direction 30 of one of the segments, whereby it can be seen that the tapers 16 each have a tapered cross-section 18 orthogonal to the longitudinal extent 6 of the metal sheet 5 in the form of a triangle 19. The tapered cross-sections 18 are convex in some areas and concave in others, whereby the contour of the tapered cross-section 18 can be influenced by the type of separation process (for example, a purely convex shape could be achieved by blunt tearing).

Using component element 1 as an example, which can be formed as shown in FIG. 5f, exactly four notches 13 were made in the flat metal sheet 5 parallel to the longitudinal extent 6, arranged in pairs on the two cover surfaces 7, whereby the component element 1 can be formed by breaking off twice in succession over the four notches 13 of the metal sheet 5 (and subsequent bending).

A large number of two opposite notches 13 were arranged on the two outer surfaces 7 of the metal sheet 5, orthogonally to one of the two outer surfaces 7 and one above the other. The metal sheet 5 was mechanically separated at two notches 13 one above the other. The separation process can be carried out by tensile and/or compressive stress.

The tapers 16 (and the further tapers 52 shown in FIG. 6) each form an angle 31 between 75° and 105° with each other. Both longitudinal surfaces 51 (or end surface 17 according to FIG. 6) are essentially free of burrs with regard to injuries during use, whereby in general only one longitudinal surface 51 (or end surface 17) may be machined in this way.

The metal sheet 5 was cut in the area of the notches 13 without separation, punching, or waste, whereby the notches 13 were broken or split and used as predetermined breaking points during bending or separation of the metal sheet 5, so that a component element 1 could be generated for which no (for safety reasons necessary) chip-removing post-processing step is required.

The metal sheet 5 has a wall thickness 2 0 of 0.7 mm, wherein wall thicknesses in the range between 0.5 mm and 1.8 mm are preferred.

FIG. 6 shows a component element 1 in the form of a drawer rail 3, wherein the metal sheet 5 in the region of the two longitudinal surfaces 51 has been folded to form a fold 21 during bending of the metal sheet 5 to form the profile 15.

In this component element 1, in addition to the notches 13 and tapers 16, a further notch 50 has been arranged in the metal sheet 5 parallel to the longitudinal extent 6. The metal sheet 5 can be mechanically separated in a bent or unbent state in the area of this additional notch 50 to form a substantially burr-free additional taper 52 on an end face 17 of component element 1. Here too, the separation process can be carried out, for example, by splitting or bending.

One of the two end surfaces 17 of the profile 15 is formed with a further taper 52, whereby further tapers 52 may generally also be provided on both end surfaces 17.

The taper cross-section 18 of the further tapers 52 is (analogous to the tapers 16) in the form of a convex triangle 19, wherein the geometry of the further tapers 52 is generally arbitrary and can be influenced by the further notches 50 and depending on the mechanical separation method.

1. A method for manufacturing at least one component element for a furniture fitting, in particular a rail, particularly preferably for a drawer pull-out guide, comprising in chronological order:
providing a flat metal sheet with a longitudinal extent, two outer surfaces and two side faces spaced apart by a width of the metal sheet as a semi-finished product for at least one component element, preferably a rail,
providing the metal sheet with at least one notch on at least one cover face, preferably by at least one stamping punch and/or at least one stamping roll, wherein the at least one notch is arranged substantially parallel to the longitudinal extent,
mechanically separating the metal sheet in the region of the at least one notch, preferably broken off, particularly preferably bent and divided,
bending the separated metal sheet so that a profile of the at least one component element, preferably rail, is formed in a cross section orthogonal to the longitudinal extent.

2. The method according to claim 1, wherein the at least one component element is formed with a substantially burr-free taper on at least one, preferably two, longitudinal surfaces of the profile, wherein it is preferably provided that the taper has a taper cross-section orthogonal to the longitudinal extent of the metal sheet essentially in the form of a preferably isosceles triangle, wherein the taper cross-section is particularly preferably convex and/or concave.

3. The method according to claim 1, wherein at least two opposite notches are arranged on the two outer surfaces of the metal sheet, preferably in one direction orthogonal to at least one of the two outer surfaces and superimposed on one another.

4. The method according to claim 1, wherein the metal sheet is mechanically separated, preferably broken off, particularly preferably bent and divided at at least two, preferably at least two superimposed notches.

5. The method according to claim 1, wherein the metal sheet is broken in the region of the at least one notch without separation, punching or cutting, wherein the at least one notch is used as a predetermined breaking point during bending or separating of the metal sheet, wherein it is preferably provided that the at least one component element is formed without post-processing.

6. The method according to claim 1, wherein the metal sheet has a wall thickness in the range of 0.5 mm and 1.8 mm, preferably between 0.6 mm and 0.8 mm.

7. The method according to claim 1, wherein the metal sheet is folded into a fold in the region of at least one longitudinal surface, preferably during the bending of the metal sheet.

8. The method according to claim 1, wherein the at least one notch is in the form of a groove or a profiling with an opening angle in the range between 40° and 140°, preferably between 75° and 105°, particularly preferably essentially 90°, and is formed in the metal sheet.

9. The method according to claim 1, wherein the at least one notch has a notch cross-section orthogonal to the longitudinal extent of the metal sheet in the form of a triangle, a trapezoid, an ellipse segment, and/or a circle segment.

10. The method according to claim 1, wherein for each component element, exactly two or four notches are made in the metal sheet parallel to the longitudinal extent, arranged in pairs on the two outer surfaces, wherein the component element is formed by breaking once or twice, preferably consecutively, breaking off over the two or four notches of the metal sheet.

11. The method according to claim 1, wherein the metal sheet has a plurality of notches arranged in pairs on the two outer surfaces and subsequently a plurality of component elements are mechanically broken off.

12. The method according to claim 1, wherein at least one further notch is arranged in the metal sheet transversely, preferably substantially parallel, to the longitudinal extent, wherein it is preferably provided that the metal sheet, which is particularly preferably bent, is mechanically separated, particularly preferably broken off or bent and divided, in the region of the at least one further notch to form at least one further taper that is essentially burr-free on at least one end face of the component element.

13. A drawer pull-out guide for movably mounting a drawer on a furniture carcass, comprising:
at least one carcass rail to be fastened to the furniture carcass, and
at least one drawer rail to be connected to the drawer, which is mounted so as to be displaceable relative to the at least one carcass rail in a longitudinal direction, and
optionally at least one center rail, which is arranged at least in some areas between the at least one carcass rail and the at least one drawer rail, and
optionally at least one container rail for arrangement on the at least one drawer rail and/or on the drawer,
wherein the at least one carcass rail and/or the at least one drawer rail has, in a cross-section orthogonal to the longitudinal direction, a profile formed from at least one metal sheet, wherein the at least one carcass rail and/or the at least one drawer rail and/or the at least one center rail, if present, and/or the at least one container rail, if present, is produced as component element by a method according to claim 1, so that at least one, in particular two, longitudinal surface of the profile of the at least one carcass rail and/or the at least one drawer rail and/or the at least one center rail, if present, and/or the at least one container rail, if present, is formed with a taper.

14. The drawer pull-out guide according to claim 13, wherein at least one, in particular two, end surfaces of the profile of the at least one body rail and/or of the at least one drawer rail and/or of the at least one center rail, if present, and/or of the at least one container rail, if present, are formed with a further taper.

15. The drawer pull-out guide according to claim 13, wherein the taper and/or the further taper forms an angle in the range between 60° and 140°, preferably between 75° and 105°, particularly preferably essentially 90°, wherein preferably at least one, preferably both, longitudinal surface and/or end surface are essentially burr-free.

16. The drawer pull-out guide according to claim 13, wherein the at least one carcass rail and/or the at least one drawer rail has at least one fastening section with a fastening side, which, when mounted on the furniture carcass or at least one furniture element, can be brought into contact with the furniture carcass or the at least one furniture element at least in sections, wherein the at least one fastening section has at least one, preferably circular, opening for the passage of a fastening means, preferably a screw, wherein the at least one opening is surrounded on one of the fastening side by a material thickness of the fastening section, preferably between 0.5 mm and 1.8 mm, particularly preferably between 0.6 mm and 0.8 mm, spaced second side by a bead which projects transversely from the second side.

17. The drawer pull-out guide according to claim 13, wherein the at least one carcass rail and/or the at least one drawer rail and/or the at least one center rail, if present, and/or the at least one container rail, if present, are formed in the region of at least one profile surface of the profile to form a fold.

18. The drawer pull-out guide according to claim 13, wherein the at least one taper and/or the at least one further taper has a tapered cross-section parallel and/or orthogonal to the longitudinal extent of the metal sheet essentially in the form of a triangle, preferably an isosceles triangle, wherein it is preferably provided that the tapered cross section is convex and/or concave.

19. The drawer pull-out guide according to claim 13, wherein the profile has at least one embossing oriented preferably orthogonally to the longitudinal extent of the metal sheet for stiffening the profile, wherein it is preferably provided that the at least one embossing extends over at least two essentially orthogonal profile surfaces and/or at least two embossings are provided, which are arranged alternately in the direction of an inner region and in the direction of an outer region of the profile.
